(19) United States
(12) Patent Application Publication
(10) Pub. No.: US 2007/0023542 A1
(43) Pub. Date: Feb. 1, 2007

(54) Fuel injector with variable actuator stroke transmission

(75) Inventor: Wolfgang Stoecklein, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(73) Assignee: ROBERT BOSCH GMBH, Stuttgart (DE)

(21) Appl. No.: 10/557,785

(22) PCT Filed: Mar. 15, 2005
(86) PCT No.: PCT/EP05/51168

§ 371 Date: Nov. 18, 2005

(30) Foreign Application Priority Data
Jun. 11, 2004 (DE) 102004028522.5

(51) Int. Cl. F02M 47/02; F02M 63/00; F02M 51/00; F02M 59/00

(52) U.S. Cl. 239/88; 239/533.2; 239/585.5

(57) ABSTRACT

The invention relates to a fuel injector with a piezoelectric actuator that actuates an injection valve member. This piezoelectric actuator acts on the injection valve member, which a spring element acts on in the closing direction. The fuel injector has a hydraulic coupling chamber that hydraulically couples a transmission piston to the injection valve member. A sleeve-shaped body rests against the injection valve member and cooperates with an edge that constitutes an intermediate stroke stop for the injection valve member.

### TECHNICAL FIELD

In addition to unit injector fuel injection systems, modern autoignition internal combustion engines also currently use high-pressure accumulator (common rail) injection systems. In high-pressure accumulator injection systems, the individual fuel injectors respectively associated with the cylinders of the internal combustion engine are supplied with fuel from a high-pressure accumulator (common rail). The fuel injectors can be actuated either by means of solenoid valves or by means of piezoelectric actuators. If the fuel injectors are actuated by means of piezoelectric actuators, then it is also possible to produce an injection valve member that can be actuated directly by means of the piezoelectric element.

### PRIOR ART

DE 697 20 145 C2 has disclosed an injection valve. The injection valve has a valve needle that a spring contained inside a spring chamber presses against a seat surface. The spring is clamped between a movable stop and a spring support connected to the valve needle. A constricted flow path is provided, through which a limited quantity of fuel can flow from the spring chamber at a limited speed. The injection valve also has a valve that includes a moving stop surface; this valve can be actuated during operation of the injection valve in such a way that a second, higher quantity of fuel can flow from the spring chamber at a second, higher speed. The valve is comprised of a seat surface that is situated around an opening that communicates with the spring chamber; the movable stop can come into contact with the seat surface so that it is possible to control the fuel flow through the opening. The movable stop can be designed to move in reaction to the fuel pressure inside a pump chamber.

In fuel injectors with directly controllable injection valve members, in order for an actuator to be able to open the injection valve member, it is necessary for the actuator to overcome a powerful opening force. The powerful opening force required, which is to be exerted by means of the actuator, is due to the fact that the injection valve member, which can be embodied in the form of a nozzle needle, is pressed into its seat through exertion of system pressure (pressure level in the high-pressure accumulator). The forces required to lift the injection valve member away from its seat are usually several hundred N, for example 400 N. In order to assure a sufficient fuel flow through the injection openings into the combustion chamber of an autoignition internal combustion engine when the injection valve member is fully open, it is also necessary for the injection valve member to execute a maximum stroke of several 100 μm, e.g. in the range between 200 μm and 300 μm. The above-mentioned values, i.e. the force of several hundred N required to open the injection valve member and the maximum achievable stroke of the injection valve member from its fully closed position into its fully open position, are essentially the determining parameters for the size of a piezoelectric actuator to be integrated into a fuel injector. Although the length/diameter ratio of the piezoelectric actuator can in fact be varied by means of an integrated hydraulic transmission, the size of the actuator, also referred to as actuator volume, is essentially proportional to the opening force to be exerted and to the maximum stroke to be executed by the injection valve member, which can be embodied in the form of a needle.

### DEPICTION OF THE INVENTION

By means of a variable transmission mechanism, the embodiment according to the present invention makes it possible for the forces that are required to move the needle-shaped injection valve member to be adapted to the forces of an actuator that is integrated into the fuel injector for direct triggering of the injection valve member. It is thus possible to make optimal use of the actuator volume, i.e. its size, and to keep the actuator, which is to be integrated into the fuel injector, very small. In addition, with the embodiment according to thefv present invention, in a fuel injector that is actuated by a piezoelectric actuator and triggers the injection valve member directly, small injection quantities can be achieved in a stable fashion since the variable transmission mechanism functions like an intermediate stroke stop for the injection valve member that can be embodied in the form of a needle. In general, intermediate stroke positions of an injection valve member, i.e. intermediate strokes, that must be produced in ballistic operating positions of the injection valve member without the latter being supported against a stop, are difficult to maintain and extremely difficult to reproduce. The variable transmission mechanism according to the present invention makes it possible to stabilize this critical operating state of an injection valve member embodied in the form of a needle, i.e. makes it reproducible.

The achievement of an intermediate stroke position situated between the closed position of the injection valve member and the open position of the injection valve member also takes into account the fact that if a preinjection is to be executed or if small quantities are to be injected, a definite stroke of the injection valve member must be produced, even when there are fluctuations, i.e. variations, in the triggering voltage of the piezoelectric actuator.

### DRAWINGS

The embodiment according to the present invention will be explained in detail below in conjunction with the drawings.

FIG. 1 shows a fuel injector having an injection valve member, which can be directly actuated by means of a piezoelectric actuator, and having a variable transmission mechanism,

FIG. 2 shows an embodiment variant of the transmission mechanism shown in FIG. 1, having an additional sleeve encompassing a preliminary stroke sleeve,

FIG. 3 shows another embodiment variant of a variable transmission mechanism, having shim rings situated at both ends of the preliminary stroke sleeve,

FIG. 4.1 shows the voltage curve in the piezoelectric actuator plotted over time,

FIG. 4.2 shows the actuator stroke plotted over time,

FIG. 4.3 shows the pressure curve in the hydraulic coupling chamber between the injection valve member and the variable transmission mechanism,

FIG. 4.4 shows the stroke curve of an injection valve member that can be embodied in the form of a needle, and

FIG. 5 shows the compared characteristic curves of the switching energy and the opening pressures, as well as the force/stroke characteristic curves of fuel injectors, with and without a variable transmission mechanism.

### EMBODIMENT VARIANTS

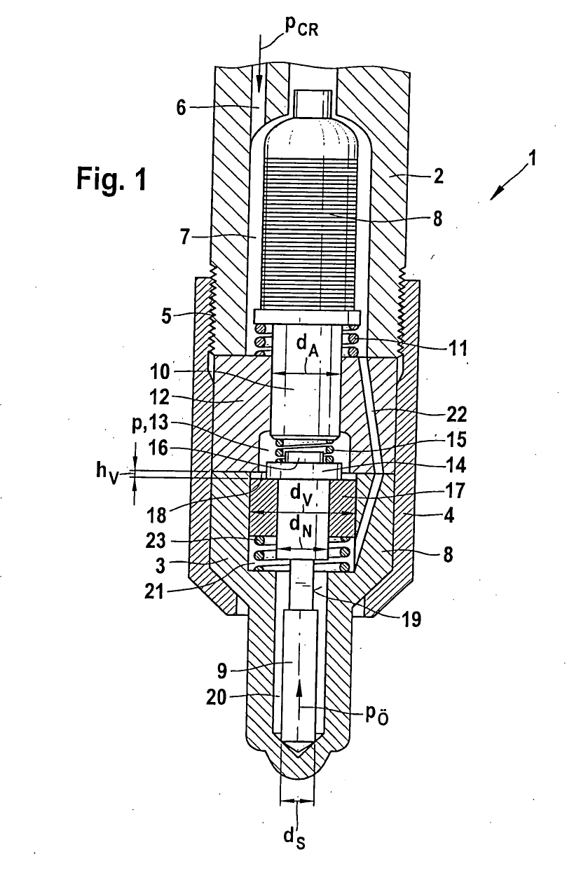

FIG. 1 shows a fuel injector whose needle-shaped injection valve member is directly actuated by a piezoelectric actuator, which is integrated into the fuel injector and is associated with a variable transmission mechanism.

It is clear from the depiction according to Fig. that a fuel injector 1 has an injector body 2 and a nozzle body 3. The nozzle body 3 and the injector body 2 are connected to each other in a sealed fashion by means of a clamping sleeve 4, for example at a screw connection 5.

The injector body 2 of the fuel injector 1 is provided with a high-pressure fitting 6 in which fuel at system pressure, i.e. fuel at the pressure prevailing in the high-pressure accumulator (common rail), flows into a cavity 7 of the injector body 2. The system pressure is labeled p_{CR}. From the cavity 7, which contains a piezoelectric actuator 8, the fuel at system pressure flows through a high-pressure inlet 22 to a high-pressure chamber 21. From there, the fuel at system pressure p_{CR} flows via open areas 19 embodied on the circumference of a needle-shaped injection valve member 9, to an annular gap 20 whose end oriented toward the combustion chamber can be provided with injection openings not shown in FIG. 1, for example in the form of one or more concentric rows of holes.

Between the injector body 2 and the nozzle body 3, is a disk 12 that functions as a guide for a piston 10 of the variable transmission mechanism. The piston 10 is encompassed by the disk 12 and prestressed by means of a piston spring 11. One end of the piston spring 11 rests against the upper, flat side of the disk 12 and the other end rests against the underside of the piezoelectric actuator 8. The diameter of the piston 10 is labeled d_{A}.

The end of the piston 10 protrudes into a coupling chamber 13. The coupling chamber 13 contains a spring element 15 that can be embodied, for example, in the form of a coil spring. Underneath the coupling chamber 13, the nozzle body 3 contains a preliminary stroke sleeve labeled with the reference numeral 17. A spring element 23 presses the preliminary stroke sleeve against a collar 14 in the upper region of the injection valve member 9 that can be embodied in the form of a needle. In the coupling chamber 13, the spring element 15 is centered on a centering pin 16 above the collar 14 on the injection valve member 9. The spring element 15, which can be embodied for example in the form of a coil spring, acts on the injection valve member 9, which can be embodied in the form of a needle, in the closing direction, i.e. moves it into its seat, which is labeled with the diameter d_{S}.

The diameter of the engine valve member 9, which can be embodied in the form of a needle, is labeled d_{N} and the outer diameter of the preliminary stroke sleeve 17 is labeled d_{V}.

FIG. 1 shows that the spring element 23 presses the preliminary stroke sleeve 17 against the collar 14 at the upper and of the injection valve member 9, which can be embodied in the form of a needle. The upper end of the preliminary stroke sleeve 17 thus rests against the collar 14 of the injection valve member 9. The upper end of the preliminary stroke sleeve, however, is situated a definite distance h_{V} away from an edge 18 of the flat surface at the bottom of the disk 12 that contains the coupling chamber 13.

The spring element 15 presses the injection valve member 9 into its seat at the combustion chamber end of the nozzle body 3. The spring element 23 in the high-pressure chamber 21 continuously presses the preliminary stroke sleeve 17 against the collar 14 on the injection valve member 9, which can be embodied in the form of a needle, which establishes a definite starting position for the preliminary stroke sleeve 17, represented by the definite distance h_{V}. In the following, it is assumed that the piezoelectric actuator 8 of the fuel injector 1 is being supplied with voltage, i.e. its piezoelectric crystals have lengthened in the vertical direction.

If the voltage U in the piezoelectric actuator 8 is reduced, then the piston 10 moves out from the coupling chamber 13 due to the action of the piston spring 11 on the piston 10. This reduces the pressure p in the coupling chamber. The more the voltage U in the piezoelectric actuator 8 is reduced, the greater the reduction in the pressure p in the coupling chamber. When a critical opening pressure p_{Ö} has been reached, the needle-shaped injection valve member 9 opens. The opening pressure p_{Ö,1} is defined by the system pressure p_{CR}, the seat diameter d_{S} of the injection valve member 1, which can be embodied in the form of a needle, and the diameter d_{V} of the preliminary stroke sleeve 17 according to the following equation:
p_{Ö,1}=P_{CR}(d_{V}²−d_{S}²)/d_{V}².

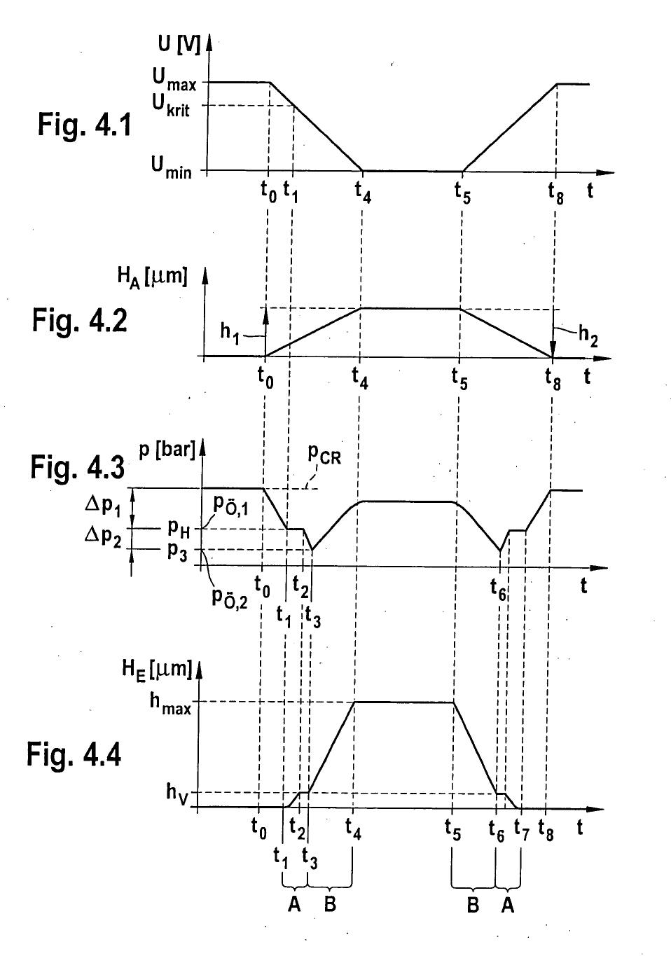

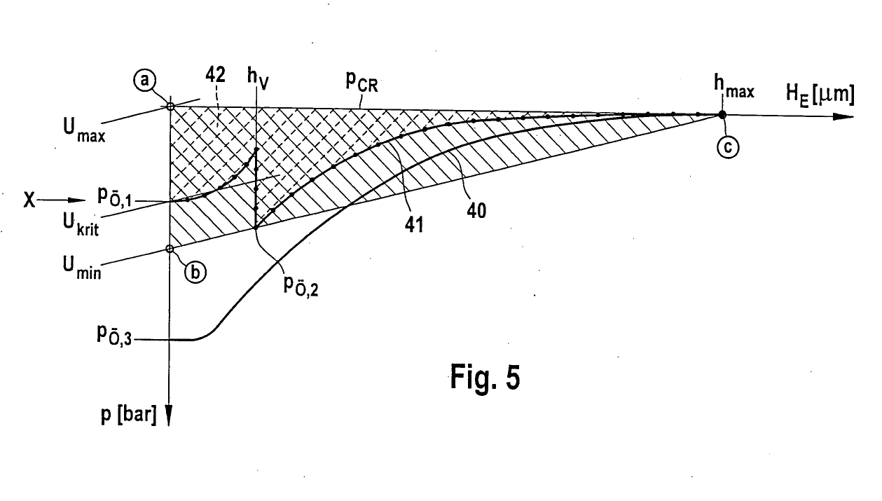

A relatively large definite diameter d_{V} of the preliminary stroke sleeve 17 results in rather a high opening pressure p_{Ö} of the injection valve member 9, which can be embodied in the form of a needle. Because of this fact, the voltage U in the piezoelectric actuator 8 need only be reduced slightly until the needle-shaped injection valve member 9 opens (also see FIGS. 4.1 through 4.4 and FIG. 5).

The needle-shaped injection valve member 9 then moves together with the preliminary stroke sleeve 17 and thus at a slower speed than the piston 10. The resulting speed transmission ratio is determined by the transmission ratio i₁=d_{A}²/d_{V}².

On the other hand, the opening force resulting from the pressure infiltration of the seat (d_{S}) of the injection valve member 9, which can be embodied in the form of a needle, is reduced at the same ratio and acts on the piezoelectric actuator 8.

Only when the upper end of the preliminary stroke sleeve 17 has reached the stop 18 at the flat surface at the bottom of the disk 12 does the transmission ratio change from i₁ to i₂=d_{A}²/d_{N}².

Further opening of the injection valve member 9, which can be embodied in the form of a needle, requires further reduction of the pressure in the coupling chamber 13, i.e. further reduction of the voltage U in the piezoelectric actuator 8.

Once a second critical opening pressure p_{Ö,2} has been reached, the nozzle needle-shaped injection valve member 9 opens and follows the movement of the piezoelectric actuator 8 with the currently effective transmission ratio i₂. The second critical opening pressure p_{Ö,2} depends essentially on the level of the pressure below the (partially open) nozzle seat d_{S} and therefore cannot be precisely indicated.

If it is necessary to inject only a second, smaller injection quantity to the combustion chamber of the autoignition internal combustion engine, then the needle-shaped injection valve member 9 advantageously remains against the stop 18 of the preliminary stroke sleeve 17 on the flat surface at the bottom of the disk 12 until the voltage U in the piezoelectric actuator 8 is increased again, which results in a closing of the needle-shaped injection valve member 9.

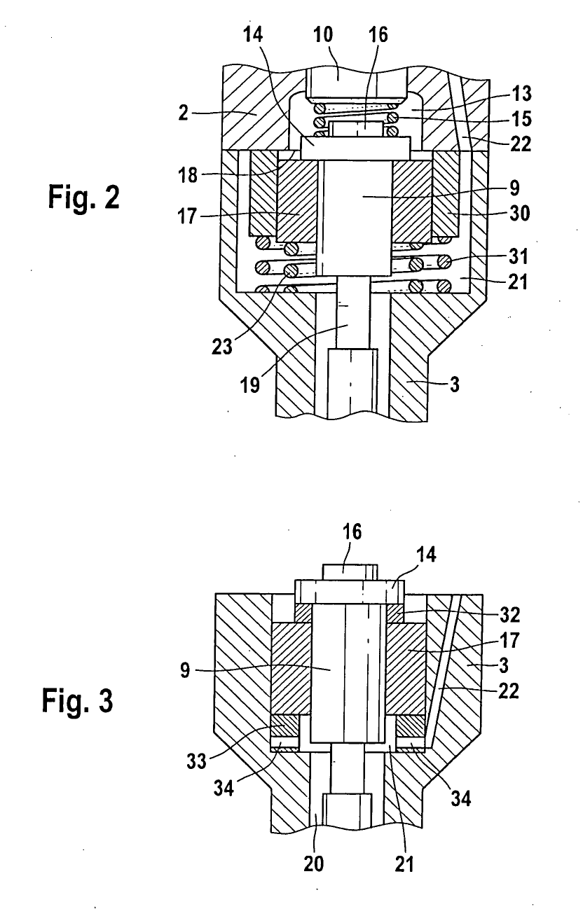

FIG. 2 shows another embodiment variant of a variable transmission mechanism in which the preliminary stroke sleeve is encompassed by another sleeve that is prestressed by a spring element.

By contrast with the embodiment according to FIG. 1, the preliminary stroke sleeve 17, which rests against an upper collar 14 of the injection valve member 9, which can be embodied in the form of a needle, is encompassed by an additional sleeve 30. The additional sleeve 30 is in turn prestressed by means of a prestressing spring 31. The prestressing spring 31 is situated between the lower end of the additional sleeve 30 and the bottom of the high-pressure chamber 21 in the nozzle module 3. The additional sleeve 30 encompassing the preliminary stroke sleeve 17 permits a radial assembly compensation when the injection body 2 and nozzle body 3 are assembled. In the embodiment variant according to FIG. 2 as well, a hydraulic coupling chamber 13 that contains the spring 15, which acts on the needle-shaped injection valve member 9 in the closing direction, is formed between the piston 10 and the upper region of the injection valve member 9, which can be embodied in the form of a needle. In order to permit fuel, which flows into the high-pressure chamber 21 via the high-pressure chamber inlet 22 at system pressure p_{CR}, to flow out in the direction of the injection openings at the combustion chamber end of the nozzle body 3, the circumference surface of the injection valve member 9, which can be embodied in the form of a needle, is provided with a number of open areas 19, which permit the fuel to flow past.

FIG. 3 shows another embodiment variant of the variable transmission mechanism according to the present invention.

The collar 14 is situated in the upper region of the needle-shaped injection valve member 9. A first shim ring 32 is accommodated between the upper end of the preliminary stroke sleeve 17 and the bottom of the collar 14 and a second shim ring 33 is situated at the bottom end of the preliminary stroke sleeve 17. The second shim ring 33 is provided with one or more openings 34 so that fuel flowing into the high-pressure chamber 21 via the high-pressure inlet 22 at system pressure p_{CR} can pass through the second shim ring 33. From the high-pressure chamber 21, the fuel flows along the annular gap 20 in the direction toward the injection openings situated at the combustion chamber end of the fuel injector 1. The injection openings can be embodied in the form of a single row of holes or in the form of several rows of holes situated concentric to one another.

The sequence of FIGS. 4.1, 4.2, 4.3, 4.4 shows, one above another, the voltage curve in the piezoelectric actuator 8, the stroke curve of the piezoelectric actuator 8, the pressure curve of the pressure p in the coupling chamber 13, and the stroke curve of the injection valve member 9, which can be embodied in the form of a needle, each plotted over the time axis.

At time t₀, the actuator voltage U in the piezoelectric actuator would be Uₘₐₓ, i.e. the piezoelectric crystals of the piezoelectric actuator are supplied with the maximum current and therefore are elongated to a maximum degree. At time t₀, the actuator stroke H_{A} is h₁ and the coupling chamber pressure p at time t₀ is P_{CR} (rail pressure). At time t₀, the injection valve member 9, which can be embodied in the form of a needle, is fully open.

At time t₁, the maximum voltage Uₘₐₓ falls to a critical value Uₖᵣᵢₜ. As a result, the elongation of the piezoelectric crystals of the piezoelectric actuator 8 diminishes by a small amount. The piston 10 travels out from the preliminary stroke sleeve 17 so that at time t₁, a pressure p in the coupling chamber 13 falls by Δp₁. As a result, the injection valve member 9, which can be embodied in the form of a needle, begins its opening movement. At time t₂, the pressure p in the coupling chamber 13 is p_{H}, which corresponds to a holding pressure, see p_{H}=p_{Ö,2}.

With a further decrease in the actuator voltage U in the piezoelectric actuator 8, the piston 10 travels farther out of the coupling chamber 13 so that a second pressure decrease Δp₂ in the coupling chamber 13 occurs until time t₃. At time t₃, the injection valve member 9 has passed the definite distance h_{V}, i.e. has executed a preliminary stroke and is now slightly open. Time t₃ marks the end of the decrease region A in which the injection valve member 9, which can be embodied in the form of a needle, moves together with the preliminary stroke sleeve 17 and more slowly than the piston 10. The speed transmission in region A is determined by the transmission ratio i₁=d_{A}²/d_{V}².

If the definite distance h_{V} has been passed, i.e. if the upper end of the preliminary stroke sleeve 17 is resting against the stop 18 at the bottom end of the disk 12, then the transmission ratio changes to i₂=d_{A}²/d_{N}². As the actuator voltage U decreases further, the transmission ratio i₁ changes to i₂ so that when a second critical opening pressure p_{Ö,2} has been reached, the needle-shaped injection valve member 9 opens in the increase region. At time t₄, the actuator voltage Uₘₐₓ has fallen to its minimum value Uₘᵢₙ, i.e. the piezoelectric crystals of the piezoelectric actuator 8 are then no longer being supplied with current so that the elongation of the actuator equals 0. According to FIG. 4.4, at time t₄, the injection valve member 9, which can be embodied in the form of a needle, is in its maximum open position, i.e. has executed the maximum stroke hₘₐₓ. During the interval of time between t₄ and t₅, in which the actuator voltage U assumes its minimum value Uₘᵢₙ, the maximum possible quantity of fuel is injected into the combustion chamber of the autoignition internal combustion engine.

At time t₅, current is once again supplied to the actuator so that its stack of piezoelectric crystals once again begins to lengthen. As a result, the pressure in the coupling chamber decreases again in the time interval between t₅ and t₆, and the injection valve member 9, which can be embodied in the form of a needle, is moved from its maximum opening stroke hₘₐₓ in the direction toward its closed position until the definite distance h_{V} has been reached at time t₆. Between times t₆ and t₇, the top of the preliminary stroke sleeve 17 and the stop 18 on the flat surface at the bottom of the disk 12 once again assume the definite distance h_{V}, which corresponds to a pressure increase by Δp₂ in the coupling chamber 13 between the piston 10 and the top end of the injection valve member 9.

Between times t₇ and t₈, a pressure increase by Δp₁ occurs in the coupling chamber 13 because the actuator voltage U in the piezoelectric actuator 8 increases once again to the maximum voltage Uₘₐₓ.

FIG. 5 depicts opening force curves of injection valve members in fuel injectors that are embodied with and without stepped transmissions.

In FIG. 5, the pressure p in the coupling chamber 13 is plotted over the stroke H_{E} of the injection valve member 9, which can be embodied in the form of a needle.

The opening force curve 40 for a piezoelectric actuator that actuates a fuel injector without a stepped transmission demonstrates that the opening pressure p_{Ö,3} of the fuel injector lies significantly below the opening pressure p_{Ö,1} of a fuel injector that operates with a piezoelectric actuator equipped with a stepped transmission. According to the opening force curve 40, a piezoelectric actuator operating without a stepped transmission requires a switching energy depicted by the shaded region represented by the triangle a-b-c in FIG. 5.

The second opening pressure p_{Ö,2} of the injection valve member 9, which can be embodied in the form of a needle, is thus significantly lower in a fuel injector equipped with a piezoelectric actuator and a stepped transmission. This also means that a lower actuating force is required in order to move the injection valve member, thus permitting a piezoelectric actuator 8 of this kind to have a small volume.

According to the opening force curve 41 for a fuel injector equipped with a piezoelectric actuator 8 and a stepped transmission, the pressure p in the coupling chamber decreases when a definite distance h_{V} is reached, then increases again sharply in a pressure jump, and then decreases again degressively toward the system pressure p_{CR}. When the maximum opening stroke of the injection valve member 9, which can be embodied in the form of a needle, has been reached, the pressure p in the coupling chamber 13 is identical to the system pressure p_{CR}.

A fuel injector whose injection valve member 9 is triggered directly with a piezoelectric actuator 8—see reference numeral 42 and the dash-shaded region in FIG. 5—has a considerably lower switching energy, thus permitting a corresponding piezoelectric actuator 8 to be smaller without impairing the function of a fuel injector with a directly triggered injection valve member 9, which can be embodied in the form of a needle.

The embodiment according to the present invention achieves an optimum utilization of the properties of the piezoelectric actuator 8 and adapts them to the stroke/force characteristic curve of an injection valve member 9 by means of a variable transmission. Consequently, it is also possible to achieve stable, extremely low injection quantities by means of an intermediate stroke stop that is defined by the edge 18 (see definite distance h_{V} between the edge 18 and the upper end of the preliminary stroke sleeve 17).

### REFERENCE NUMERAL LIST

1 fuel injector
2 injector body (holding body)
3 nozzle body
4 clamping sleeve
5 screw connection
6 high-pressure fitting
7 cavity
8 piezoelectric actuator
9 injection valve member
10 piston
11 piston spring
d_{A} diameter of piston 10
12 disk
13 coupling chamber
14 injection valve member collar
15 spring element
H_{V} definite distance (intermediate stop)
16 centering pin
17 preliminary stroke sleeve
d_{V} diameter of preliminary stroke sleeve
18 stop edge

1-10. (canceled)

11. A fuel injector comprising
an actuator,
an injector valve member directly actuated by the actuator,
a spring element acting on the injection valve member in the closing direction,
a hydraulic coupling chamber hydraulically coupling a transmission piston to the injection valve member, and
a sleeve-shaped body resting against the injection valve member and cooperating with an edge that constitutes an intermediate stroke position of the injection valve member.

12. The fuel injector according to claim 11, wherein the sleeve-shaped body is able to move in relation to the injection valve member.

13. The fuel injector according to claim 12, wherein that a relative movement of the injection valve member in relation to the sleeve-shaped body occurs after a definite stroke h_{V} between the sleeve-shaped body and the edge has been reached.

14. The fuel injector according to claim 13, wherein with a first pressure decrease Δp₁ of the coupling chamber until the definite stroke h_{V} has been reached, the sleeve-shaped body and the injection valve member move together at a first speed ratio i₁.

15. The fuel injector according to claim 14, wherein the first speed ratio i₁ is determined by d_{A}²/d_{V}², where d_{A} is the diameter of the piston and d_{V} is the diameter of the preliminary stroke sleeve.

16. The fuel injector according to claim 13, wherein when a definite stroke h_{V} is exceeded and a second pressure decrease Δp₂ occurs in the coupling chamber, the injection valve member moves with a second speed transmission i₂.

17. The fuel injector according to claim 16, wherein the second speed ratio i₂ is determined by d_{A}²/d_{N}² where d_{A} is the diameter of the piston and d_{N} is the diameter of the injection valve member.

18. The fuel injector according to claim 11, wherein in an intermediate position, the injection valve member is situated at the edge.

19. The fuel injector according to claim 11, wherein the coupling chamber is defined by the piston, the injector body, the preliminary stroke sleeve, and an additional sleeve.

20. The fuel injector according to claim 11, further comprising a first shim ring limiting the definite stroke h_{V} and a second shim ring equipped with openings, and wherein the first shim ring rests against a collar and the second shim ring rests against the wall of the high-pressure chamber.
